(19) United States
(12) Patent Application Publication
(10) Pub. No.: US 2022/0383388 A1
(43) Pub. Date: Dec. 1, 2022

(54) INFORMATION PROCESSING APPARATUS, INFORMATION PROCESSING METHOD, AND NON-TRANSITORY STORAGE MEDIUM

(71) Applicant: Toyota Jidosha Kabushiki Kaisha, Toyota-shi (JP)

(72) Inventors: Yuta Tone, Nagoya-shi (JP); Yukinori II, Toyota-shi (JP); Tadayuki Tanaka, Nagoya-shi (JP); Naoki Ishizuka, Nagoya-shi (JP); Yuichiro Yano, Nagakute-shi (JP); Nariaki Amano, Nagoya-shi (JP); Yusuke Maeda, Miyoshi-shi (JP); Kei Yazaki, Okazaki-shi (JP); Yu Hamada, Nagoya-shi (JP)

(73) Assignee: Toyota Jidosha Kabushiki Kaisha, Toyota-shi (JP)

(21) Appl. No.: 17/827,030

(22) Filed: May 27, 2022

(30) Foreign Application Priority Data
May 27, 2021 (JP) 2021-089489

(51) Int. Cl. G06Q 30/06

(52) U.S. Cl. CPC G06Q 30/0631

(57) ABSTRACT

An information processing apparatus obtains information about prescribed equipment. The prescribed equipment is equipment that corresponds to a vehicle owned by a user, and is specified by a manufacturer of the vehicle as equipment that can be selected by the user. Then, the information processing apparatus proposes to the user that the prescribed equipment be newly installed on the vehicle, at a predetermined proposal timing set based on a legally defined inspection timing of the vehicle.

### CROSS REFERENCE TO THE RELATED APPLICATION

This application claims the benefit of Japanese Patent Application No. 2021-089489, filed on May 27, 2021, which is hereby incorporated by reference herein in its entirety.

### BACKGROUND

### Technical Field

The present disclosure relates to an information processing apparatus, an information processing method, and a non-transitory storage medium.

### Description of the Related Art

Patent Literature 1 discloses a technique related to a vehicle maintenance system. The vehicle maintenance system disclosed in Patent Literature 1 provides maintenance information to users based on vehicle data, which is an accumulation of various data related to vehicles, including data on mileage.

### CITATION LIST

### Patent Literature

Patent Literature 1: Japanese Patent Application Laid-Open Publication No. 2015-191525

### SUMMARY

An object of the present disclosure is to provide a technique that makes it possible to propose to a user to install new equipment on a vehicle owned by the user.

An information processing apparatus according to a first aspect of the present disclosure may include a controller configured to perform:
obtaining information about prescribed equipment that corresponds to a vehicle owned by a user, and is specified by a manufacturer of the vehicle as equipment that can be selected by the user; and
proposing to the user that the prescribed equipment be newly installed on the vehicle, at a predetermined proposal timing set based on an inspection timing of the vehicle legally defined.

An information processing method according to a second aspect of the present disclosure, which is executed by a computer, may include:
obtaining information about prescribed equipment that corresponds to a vehicle owned by a user, and is specified by a manufacturer of the vehicle as equipment that can be selected by the user; and
proposing to the user that the prescribed equipment be newly installed on the vehicle, at a predetermined proposal timing set based on an inspection timing of the vehicle legally defined.

A non-transitory storage medium according to a third aspect of the present disclosure is a non-transitory storage medium storing a program causing a computer to perform an information processing method, wherein the information processing method may include:
obtaining information about prescribed equipment that corresponds to a vehicle owned by a user, and is specified by a manufacturer of the vehicle as equipment that can be selected by the user; and
proposing to the user that the prescribed equipment be newly installed on the vehicle, at a predetermined proposal timing set based on an inspection timing of the vehicle legally defined.

According to the present disclosure, it is possible to propose to a user that new equipment be installed on a vehicle owned by the user.

### BRIEF DESCRIPTION OF THE DRAWINGS

FIG. 1 is a view illustrating a schematic configuration of an information management system;

FIG. 2 is a block diagram schematically illustrating an example of a functional configuration of each of a store terminal and a management server;

FIG. 3 is a view illustrating an example of an operation screen of the store terminal;

FIG. 4 is a view illustrating an example of a table configuration of user information stored in a user information database according to a first embodiment;

FIG. 5 is a flowchart illustrating a flow of proposal processing; and

FIG. 6 is a view illustrating an example of a table configuration of user information stored in a user information database according to a second embodiment.

### DESCRIPTION OF THE EMBODIMENTS

A variety of equipment are installed on a vehicle. Then, when purchasing a vehicle, a user can select equipment to be installed on the vehicle from among a plurality of options specified by a vehicle manufacturer as equipment that can be selected by users. However, even after purchasing the vehicle, the user may also want to replace equipment or add new equipment in the vehicle owned by the user.

In an information processing apparatus according to the present disclosure, a controller may obtain information about prescribed equipment corresponding to a vehicle owned by a user (hereinafter, may also be referred to as the “user vehicle” Here, the prescribed equipment is equipment specified by the manufacturer of the vehicle as equipment that can be selected by users.

Then, the controller may propose to the user at a predetermined proposal timing that the prescribed equipment be newly installed on the user vehicle. Here, for vehicles, an inspection timing, which is a timing at which each vehicle should be checked or inspected, is legally defined. In addition, this legal inspection timing is set at regular intervals. The predetermined proposal timing is a timing set based on such a legally defined inspection timing of the user vehicle. The predetermined proposal timing is, for example, a timing before the inspection timing of the user vehicle by a predetermined period of time.

According to this, it is possible to guide the user to newly install the prescribed equipment on the user vehicle in accordance with the timing of performing an inspection or check of the user vehicle. As a result, it is possible to encourage the user to newly install the prescribed equipment on the user vehicle.

Hereinafter, specific embodiments of the present disclosure will be described based on the accompanying drawings. The dimensions, materials, shapes, relative arrangements, and the like of the components described in the embodiments are not intended to limit the technical scope of the present disclosure only to them unless otherwise specified.

### First Embodiment

(System Configuration)

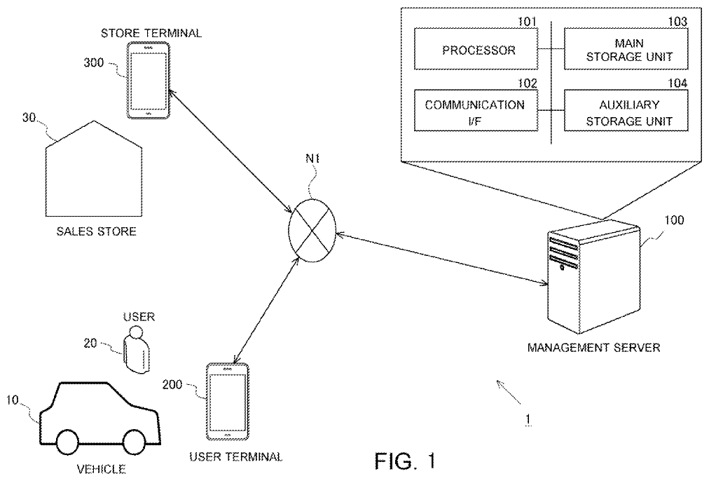

FIG. 1 is a view illustrating a schematic configuration of an information management system 1 according to a first embodiment. The information management system 1 is a system for proposing to a user to install new equipment on a vehicle owned by the user.

The information management system 1 includes a management server 100, a user terminal 200, and a store terminal 300. In the information management system 1, the management server 100, the user terminal 200, and the store terminal 300 are connected to one another via a network N1. Here, as the network N1, for example, a WAN (Wide Area Network), which is a worldwide public communication network such as the Internet, or a telephone communication network such as a cellular phone network may be adopted.

The user terminal 200 is a terminal possessed by the user 20 who owns the user vehicle 10. The store terminal 300 is a terminal used in a sales store 30 where the user 20 has purchased the user vehicle 10. The store terminal 300 is operated by a sales person in the sales store 30. The user terminal 200 and the store terminal 300 are each configured to include a computer having a processor, a main storage unit, an auxiliary storage unit, a communication interface, and an input and output interface. Examples of the user terminal 200 and the store terminal 300 may include smartphones, tablet computers, or personal computers.

The sales store 30 is a store (dealer or the like) that sells vehicles. In the sales store 30, when a customer (user) purchases a vehicle, vehicle information about the vehicle purchased by the customer is input to the store terminal 300. At the store terminal 300, user information about the user who purchased the vehicle is generated based on the input vehicle information. Then, the user information is transmitted from the store terminal 300 to the management sever 100 via the network N1. Note that details of the user information will be described later.

The management server 100 is configured to include a general computer. The computer constituting the management server 100 includes a processor 101, a communication interface (communication I/F) 102, a main storage unit 103, and an auxiliary storage unit 104.

Here, the processor 101 is, for example, a CPU (Central Processing Unit) or a DSP (Digital Signal Processor). The communication I/F 102 is, an interface for performing wireless communication via the network N1 according to a predetermined wireless communication standard. The communication I/P 102 is, for example, a LAN (Local Area Network) interface board or a wireless communication circuit for wireless communication. The main storage unit 103 is, for example, a PM (Random Access Memory). The auxiliary storage unit 104 is, for example, a ROM (Read Only Memory), an HDD (Hard Disk Drive), or a flash memory. In addition, the auxiliary storage unit 104 may also include a removable medium (portable storage medium). Here, the removable medium is, for example, a USB memory, an SD card, or a disk recording medium such as a CD-ROM, a DVD disk, or a Blu-ray disk.

The auxiliary storage unit 104 stores an operating system (OS), various programs, various information tables, and the like. The processor 101 loads a program stored in the auxiliary storage unit 104 into the main storage unit 103 and executes the program, thereby realizing processing generating a database and processing for providing information, as will be described later. However, some or all of the functions of the management server 100 may be realized by a hardware circuit such as an ASIC or an FPGA. Here, note that the management server 100 does not necessarily need to be realized by a single physical configuration, but may be composed of a plurality of computers that work together.

The management sever 100 receives the user information transmitted from the store terminal 300. In addition, the management server 100 generates a database of user information by accumulating the received user information. The database in the management server 100 also stores user information about the user 20 who is the owner of the user vehicle 10. Then, the management server 100 determines proposal equipment based on the vehicle information of the user vehicle 10 included in the user information about the user 20. Here, the proposal equipment is equipment that is proposed, to the user 20, to be newly installed on the user vehicle 10. Further, the management server 100 transmits the proposal information, which is information about the proposal equipment, to the user terminal 200 via the network. As a result, it is proposed to the user 20 that the proposal equipment be newly installed on the user vehicle 10.

(Functional Configuration)

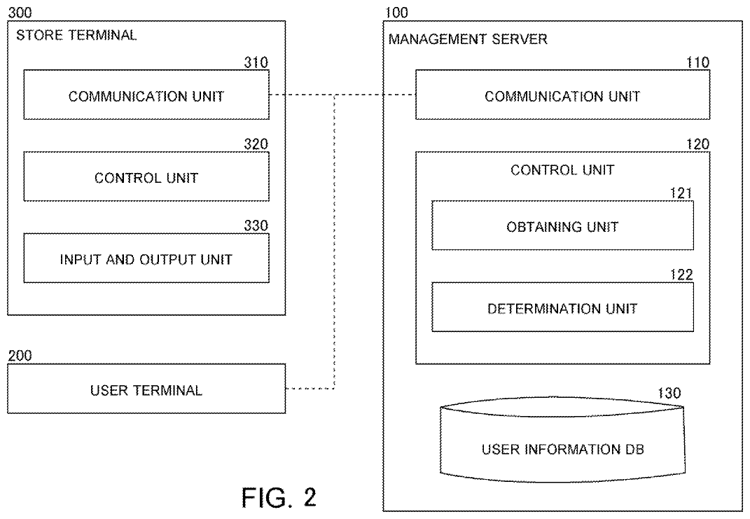

Next, a functional configuration of each of the store terminal 300 and the management server 100, which together constitute the information management system 1, will be described based on FIG. 2. FIG. 2 is a block diagram schematically illustrating an example of the functional configuration of each of the store terminal 300 and the management server 100. Note that in the present embodiment, the management server 100 corresponds to an information processing apparatus according to the present disclosure.

The store terminal 300 includes, as its functional units, a communication unit 310, a control unit 320, and an input and output unit 330. The control unit 320 has a function of performing arithmetic processing for controlling the store terminal 300. The control unit 120 can be implemented by a processor.

The communication unit 310 has a function of connecting the store terminal 300 to the network N1. The communication unit 310 can be implemented by a communication interface. Then, the control unit 320 performs the processing of transmitting the user information to the management server 100 by using the communication unit 310.

The input and output unit 330 has a function of receiving an input of information and a function of outputting information. The input and output unit 330 can be implemented by an input and output interface such as a touch panel display or like. Then, the control unit 320 performs the processing of receiving vehicle information that is input by using the input and output unit 330. Further, in the store terminal 300, the control unit 320 executes the processing of generating the user information based on the received vehicle information.

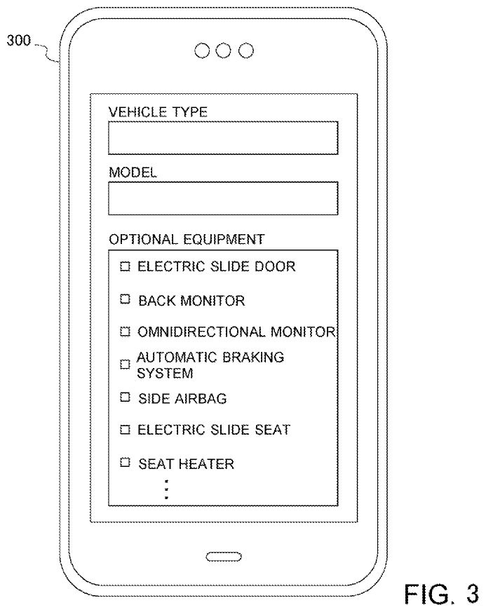

Here, at the sales store 30, vehicle information input to the store terminal 300 when the user purchases a vehicle will be described based on FIG. 3. FIG. 3 is a view illustrating an example of an operation screen displayed on a touch panel display that constitutes the input and output unit 330 in the store terminal 300. On the operation screen illustrated in FIG. 3, the type and model of the vehicle to be purchased by the user are entered. In addition, on the operation screen illustrated in FIG. 3, a list of optional equipment according to the type and model of the vehicle is displayed. Here, the optional equipment is equipment specified by the manufacturer of the vehicle as equipment that can be selected by users. In other words, the optional equipment is generally a so-called manufacturer's option (factory option) that is installed on the vehicle on the vehicle production line. The optional equipment has been set in advance by the vehicle manufacturer according to the type and model of the vehicle. As the optional equipment, there can be specifically exemplified an “electric slide door”, a “back monitor”, an “omnidirectional monitor”, an “automatic braking system”, a “side airbag”, an “electric slide seat a seat heater”, or the like, as illustrated in FIG. 3. However, the optional equipment is not limited to these pieces of equipment.

Then, on the operation screen illustrated in FIG. 3, the equipment selected by the user as the equipment to be actually installed on the vehicle (hereinafter, may also be referred to as the “installed equipment”) is entered by using the list of optional equipment. Further, on the operation screen illustrated in FIG. 3, this list of optional equipment is used to enter the equipment that has been considered by the user to be installed on the vehicle but has not actually been selected as the equipment to be installed on the vehicle by the user (hereinafter, may also be referred to as the “considered equipment”). The considered equipment is, for example, the equipment that was once considered by the user to be installed on the vehicle when an estimate of the selling price of the vehicle was prepared in order for the user to consider the purchase of the vehicle.

Then, at the store terminal 300, the control unit 320 generates user information to be transmitted to the management sever 100 based on the vehicle information input. Through the input and output unit 330 as described above. Therefore, the user information includes, as vehicle information, information about, the vehicle type, model, and optional equipment of the vehicle purchased by the user. In addition, the information about the optional equipment includes information about the installed equipment and the considered equipment.

The management server 100 includes, as its functional units, a communication unit 110, a control unit 120, and a user information database (user information DB) 130. The communication unit 110 has a function of connecting the management server 100 to the network N1, The communication unit 110 can be implemented by the communication I/F 102.

The control unit 120 has a function of performing arithmetic processing for controlling the management server 100. The control unit 120 may be implemented by the processor 101. Then, the control unit 120 performs the processing of receiving the user information transmitted from the store terminal 300 by using the communication unit 110. Further, the control unit 120 performs the processing of storing the use information received from the store terminal 300 in the user information DB 130. Note that the user information DB 130 is built in the auxiliary storage unit 104 by the processor 101 executing a program or a database management system. Every time user information is received from the store terminal 300, the control unit 120 adds the received user information to the user information IDE 130. Therefore, the user information PB 130 stores user information about each of a plurality of users.

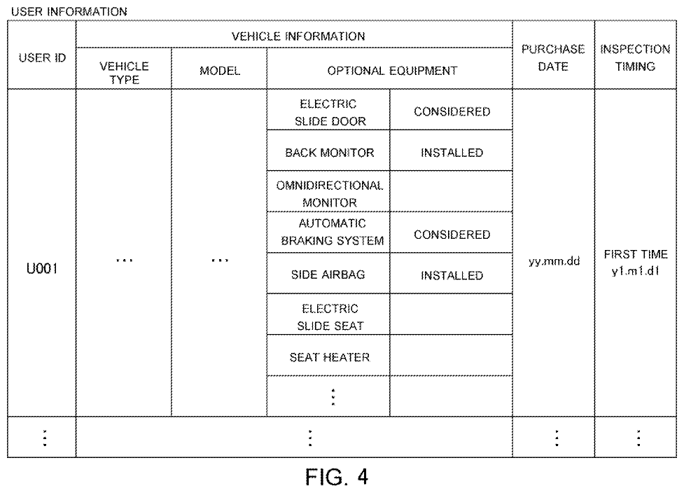

FIG. 4 is a view illustrating an example of a table configuration of the user information stored in the user information DB 130 according to the present embodiment. As illustrated in FIG. 4, the user information includes a user ID field, a vehicle information field, a purchase date field, and an inspection timing field.

In the user ID field, a user ID, which is identification information for identifying a user who purchased a vehicle, is entered. In the vehicle information field, vehicle information about the vehicle purchased by the user is entered. In other words, in the vehicle information field, information about the vehicle model, type, and optional equipment of the vehicle purchased by the user is entered. In addition, for the optional equipment, information about whether or not each piece of equipment is installed equipment, and whether nor not each piece of equipment is considered equipment, is entered. For example, in the example illustrated in FIG. 4, information indicating that a “back monitor” and a “side airbag” are installed equipment and that an “electric sliding door” and an “automatic braking system” are considered equipment is entered as information about the optional equipment.

In the purchase date field, the date on which the user purchased the vehicle is entered. In the inspection timing field, the inspection timing of the vehicle is entered. Here, the inspection timing is a regular inspection timing of the vehicle, which is legally defined. This inspection timing is defined by laws and regulations for each country. Then, in the inspection timing field, the date indicating the next inspection timing is entered. In the inspection timing field, information indicating how many times the next inspection timing is after the user has purchased the vehicle is entered. For example, in the example illustrated in FIG. 4, it is entered that the next inspection timing is “first time”.

In addition, the control unit 120 executes proposal processing for proposing to the user to install new equipment on the user vehicle, at a predetermined proposal timing after the user has purchased the user vehicle. The control unit 120 has an obtaining unit 121 and a determination unit 122 as its functional units for executing the proposal processing.

The obtaining unit 121 extracts, from the user information DB 130, user information about the user who is a target of the proposal processing. Thus, the obtaining unit 121 obtains information about the optional equipment of the user vehicle included in the user information.

Then, the determination unit 123 determines proposal equipment based on the user information obtained by the obtaining unit 121. At this time, the determination unit 122 selects the proposal equipment from among the optional equipment included in the vehicle information in the user information.

Here, a method of selecting the proposal equipment in the determination unit 122 will be described. The determination unit 122 selects the proposal equipment based on the information about how many times the vehicle is due for inspection, which is entered in the inspection timing field in the user information. More specifically, the determination unit 122 changes the proposal equipment to be selected, depending on whether the inspection timing of the vehicle the first time or the second or subsequent time.

Among the optional equipment, the considered equipment is equipment that is not currently installed on user vehicle but has been considered by the user to be installed on the user vehicle in the past. In other words, the considered equipment is the equipment that has a past record of being of interest to the user. Therefore, even if the user did not select the considered equipment as installed equipment at the time of purchasing the user vehicle, the user may again want to install the considered equipment on the user vehicle after the purchase of the user vehicle. Then, the first inspection timing after the user has purchased the user vehicle is a suitable timing for encouraging the user to install the considered equipment on the user vehicle. Therefore, when the inspection timing of the vehicle is the first time, the determination unit 122 selects the considered equipment from among the optional equipment as the proposed equipment.

On the other hand, after the user purchases the user vehicle, the installed equipment may deteriorate over time in the user vehicle. In such a case, the user may wish to replace the deteriorated installed equipment. Then, a second or subsequent one of the inspection timings, after a certain period of time has elapsed since the user purchased the user vehicle, is a suitable timing for encouraging the user to replace the deteriorated installed equipment. Therefore, when the vehicle is inspected for the second time or later, the determination unit 122 selects, as the proposal equipment, equipment that can be replaced with the installed equipment from among the optional equipment. Note that in this case, the proposal equipment at this time may be the same equipment as the installed equipment, or may be equipment that is different from the installed equipment but compatible with the installed equipment. The compatible equipment in the optional equipment is predetermined by the manufacturer of the vehicle.

Then, the control unit 120 transmits the proposal information, which is the information about the proposal equipment determined by the determination unit 122, to the user terminal of the user who is the target of the proposal processing by using the communication unit 110. That is, when the user 20 is the target of the proposal processing, the proposal information is transmitted from the management sever 100 to the user terminal 200. As a result, at the predetermined proposal timing, it is proposed to the user 20 that the proposal equipment be newly installed on the user vehicle 10.

Here, note that in the present embodiment, the user information DB 130 corresponds to a “predetermined database” according to the present disclosure. In addition, in the present embodiment, the optional equipment corresponds to the “prescribed equipment” according to the present disclosure.

(Proposal Processing)

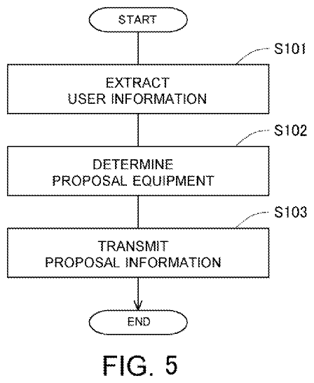

Hereinafter, a flow of the proposal processing to be executed by the control unit 120 in the management server 100 will be described based on FIG. 5. FIG. 5 is a flowchart illustrating the flow of the proposal processing. Here, a case where the proposal processing is executed for the user 20 will be described as an example. The proposal processing is executed for each user whose user information is stored in the user information DB 130.

When the predetermined proposal timing determined based on the inspection timing in the user information of the user 20 stored in the user information DB 130 arrives, the flow illustrated in FIG. 5 is executed for the user 20 by the control unit 120. In this flow, first, in S101, user information is extracted for the user 20 stored in the user information DB 130.

Then, in S102, the proposed equipment for the user 20 is determined from among the optional equipment of the vehicle information in the user information extracted in S101. At this time, when the inspection timing of the user vehicle 10 in the user information is the first time, the considered equipment of the optional equipment is determined as the proposal equipment. On the other hand, when the inspection timing of the user vehicle 10 in the user information is the second or subsequent time, the equipment, which can be replaced with the installed equipment, among the optional equipment is determined as the proposed equipment.

Note that the considered equipment, which is the proposal equipment when the inspection timing of the user vehicle 10 is the first time, may include equipment that can be replaced with the installed equipment. In addition, the equipment that can be replaced with the installed equipment, which becomes the proposal equipment when the inspection timing of the user vehicle 10 is the second time, may include the considered equipment.

Subsequently, in S103, the proposal information, which is the information about the proposal equipment determined in S102, is transmitted to the user terminal 200. At this time, the information about the inspection timing of the user vehicle 10 may be transmitted to the user terminal 200 together with the proposal information. With this, it is possible to notify the user 20 of the inspection timing of the user vehicle 10.

According to the information management system 1 of the present embodiment, it is possible to propose, to the user 20, the optional equipment that the user 20 may want to install on the user vehicle 10, in accordance with the timing at which the user vehicle 10 is inspected or checked. Therefore, it is possible to encourage the user 20 to newly install the optional equipment on the user vehicle 10 at a suitable timing.

Here, note that in the present embodiment, the equipment, which the user considered to install on the vehicle at the time of purchasing the vehicle, is used as the considered equipment. However, the considered equipment may be equipment that has once been considered by the user to be installed on the vehicle but has not actually been installed on the vehicle after the user has purchased the vehicle and before the legally defined first inspection timing of the vehicle.

### First Modification

The optional equipment in the user information about the user 20 may include equipment that, when newly installed on the user vehicle 10, will make the residual value of the user vehicle 10 higher than the current value thereof. Therefore, when determining, as proposal equipment for the user 20, the considered equipment or equipment that can be replaced with installed equipment in the proposal processing, the control unit 120 of the management sever 100 may select equipment that, when newly installed on the user vehicle 10, will make the residual value of the user vehicle 10 higher than the current value thereof, and may determine it as the proposal equipment. According to this, it becomes possible to propose to the user 20 the equipment that the user 20 is more likely to want to install on the user vehicle 10.

Here, note that whether or not each piece of equipment included in the optional equipment is equipment that, when newly installed on the user vehicle 10, will make the residual value of the user vehicle 10 higher than the current value thereof can be determined based on the market value of each piece of the equipment. Therefore, the management server 100 may obtain information about the market value of each piece of equipment included in the optional equipment. Then, based on the information about the market value of each piece of the equipment thus obtained, the control unit 120 may select equipment that, when newly installed on the user vehicle 10, will make the residual value of the user vehicle 10 higher than the current value thereof.

### Second Embodiment

A schematic configuration of an information management system according to a second embodiment is the same as that of the first embodiment. Hereinafter, differences from the first embodiment in the information management system according to the present embodiment will be mainly described.

After a user 20 purchases a user vehicle 10, optional equipment that can be installed on the user vehicle 10 may be additionally released by the manufacturer of the user vehicle 10. At this time, the user 20 may want to install the additionally released optional equipment (hereinafter, may also be referred to as the “additional option”) on the user vehicle 10.

Therefore, in the present embodiment, when optional equipment is additionally released, the management sever 100 obtains information about the additional option (additional option information). Here, when the optional equipment is additionally released, the additional option information may be input to the store terminal 300 by a sales person of the sales store 30. Then, the additional option information may be transmitted from the store terminal. 300 to the management sever 100 via the network N1. Thus, the management server 100 can obtain the additional option information. Note that the additional option information may be directly input to the management server 100.

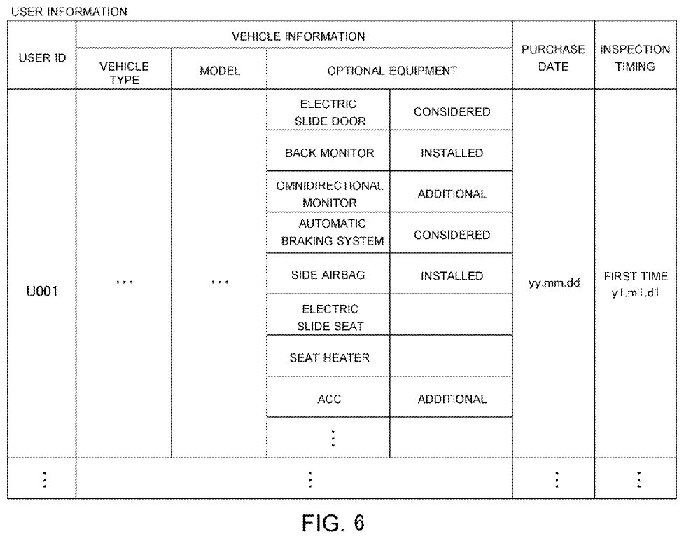

Then, in the present embodiment, in the management server 100, the control unit 120 adds the additional option to the optional equipment of the vehicle information in the user information stored in the user information DB 130. At this time, information indicating that the equipment added to the optional equipment is the additional option is also entered in the user information DB 130. FIG. 6 is a view illustrating an example of a table configuration of the user information stored in the user information DB 130 according to the present embodiment. In the example illustrated in FIG. 6, information indicating that “ACC (Adaptive Cruise Control)” is the optional equipment is entered as information about the additional option.

Then, in this embodiment, too, the management server 100 executes the proposal processing based on the user information stored in the user information DB 130. At this time, in the management server 100, the control unit 120 selects the additional option as the proposal equipment from among the optional equipment included in the vehicle information in the user information. Here, note that in the present embodiment, the control unit 120 may select the additional option, in addition to the considered equipment or the equipment that can be replaced with installed equipment, which has been selected as the proposal equipment in the same manner as in the proposal processing according to the first embodiment. Then, the control unit 120 transmits the proposal information, which is information about the determined proposal equipment, to the user terminal 200.

The additional option, unlike the considered equipment, is not the equipment that has been considered by the user 20 to be installed on the user vehicle 10 in the past. However, since the additional option is equipment newly released by the manufacturer of the user vehicle 10, the user 20 may want to install the additional option on the user vehicles 10. Therefore, according to the information management system. 1 of the present, embodiment, too, it is possible to propose to the user 20 the equipment that the user 20 may want to install on the user vehicle 10.

Here, note that in the present embodiment, when the additional option is equipment that makes the residual value of the user vehicle 10 higher than the current value thereof by being newly installed on the user vehicle 10, the additional option may be determined as the proposal equipment in the proposal process.

In addition, the information management system according to the first embodiment or the second embodiment, the store terminal 300 may have the functions of the management server 100 described above. Also, in the information management system 1, the user terminal 200 may have the functions of the store terminal 300 described above. Moreover, when the user terminal 200 stores the user information about the user 20, the user terminal 200 may have a function of executing the proposal processing described above.

### Other Embodiments

The embodiments described above are merely examples, and the present disclosure may be changed and implemented as appropriate within the scope of the disclosure. Furthermore, processes and means described in the present disclosure may be freely combined to the extent that no technical conflict exists.

Furthermore, a process that is described to be performed by one apparatus may be shared and performed by a plurality of apparatuses. Processes described to be performed by different apparatuses may be performed by one apparatus. Which function is to be implemented by which hardware configuration (server configuration) in a computer system may be flexibly changed.

The present disclosure may also be implemented by supplying computer programs for implementing the functions described in the embodiments described above to a computer, and by one or more processors of the computer reading out and executing the programs. Such computer programs may be provided to the computer by a non-transitory Computer-readable storage medium that can be connected to a system bus of the computer, or may be provided to the computer through a network. The non-transitory computer-readable storage medium may be any type of disk including magnetic disks (floppy (registered trademark) disks, hard disk drives (HDDs), etc.) and optical disks (CD-ROMs, DVD discs, Blu-ray discs, etc.), and any type of medium suitable for storing electronic instructions, such as read-only memories (ROMS), random access memories (RAMs), EPROMs, EEPROMs, magnetic cards, flash memories, or optical cards.

What is claimed is:

1. An information processing apparatus including a controller configured to perform:
obtaining information about prescribed equipment that corresponds to a vehicle owned by a user, and is specified by a manufacturer of the vehicle as equipment that can be selected by the user; and
proposing to the user that the prescribed equipment be newly installed on the vehicle, at a predetermined proposal timing set based on inspection timings of the vehicle legally defined.

2. The information processing apparatus according to claim 1, wherein
the predetermined proposal timing, which is set based on a first one of the inspection timings after the user has owned the vehicle, is defined as a first proposal timing;
the prescribed equipment, which is not currently installed on the vehicle but has been considered by the user to be installed on the vehicle in the past, is defined as first prescribed equipment; and
at the first proposal timing, the controller proposes to the user that the first prescribed equipment be newly installed on the vehicle.

3. The information processing apparatus according to claim 2, wherein
the first prescribed equipment is equipment that has been considered by the user to be installed on the vehicle upon purchase of the vehicle, but has not actually been selected as equipment to be installed on the vehicle by the user.

4. The information processing apparatus according to claim 1, wherein
the predetermined proposal timing, which is set based on a second or subsequent one of the inspection timings after the user has owned the vehicle, is defined as a second proposal timing;
the prescribed equipment, which can be replaced with equipment currently installed on the vehicle, is defined as second prescribed equipment; and
at the second proposal timing, the controller proposes to the user that the second prescribed equipment be newly installed on the vehicle.

5. The information processing apparatus according to claim 1, wherein
the prescribed equipment, which was not included in options selectable by the user when the user purchased the vehicle, is defined as third prescribed equipment; and
the controller proposes to the user at the predetermined proposal timing that the third prescribed equipment be newly installed on the vehicle.

6. The information processing apparatus according to claim 1, wherein
the controller proposes to the user that the prescribed equipment, which, when installed on the vehicle, makes a residual value of the vehicle higher than a current value thereof, be newly installed on the vehicle.

7. The information processing apparatus according to claim 1, wherein
the controller obtains information about the prescribed equipment from a predetermined database.

8. The information processing apparatus according to claim 1, wherein
the controller transmits proposal information for proposing to newly install the prescribed equipment on the vehicle to a terminal related to the user at the predetermined proposal timing.

9. An information processing method to be executed by a computer, comprising:
obtaining information about prescribed equipment that corresponds to a vehicle owned by a user, and is specified by a manufacturer of the vehicle as equipment that can be selected by the user; and
proposing to the user that the prescribed equipment be newly installed on the vehicle, at a predetermined proposal timing set based on inspection timings of the vehicle legally defined.

10. The information processing method according to claim 9, further comprising:
defining, as a first proposal timing, the predetermined proposal timing that is set based on a first one of the inspection timings after the user has owned the vehicle;
defining, as first prescribed equipment, the prescribed equipment that is not currently installed on the vehicle but has been considered by the user to be installed on the vehicle in the past; and
proposing to the user at the first proposal timing that the first prescribed equipment be newly installed on the vehicle.

11. The information processing method according to claim 10, wherein
the first prescribed equipment is equipment that has been considered by the user to be installed on the vehicle upon purchase of the vehicle, but has not actually been selected as equipment to be installed on the vehicle by the user.

12. The information processing method according to claim 9, wherein
the predetermined proposal timing, which is set based on a second or subsequent one of the inspection timings after the user has owned the vehicle, is defined as a second proposal timing;
the prescribed equipment, which can be replaced with equipment currently installed on the vehicle, is defined as second prescribed equipment; and
the information processing method further comprising:
proposing to the user at the second proposal timing that the second prescribed equipment be newly installed on the vehicle.

13. The information processing method according to claim 9, wherein
the prescribed equipment, which was not included in options selectable by the user when the user purchased the vehicle, is defined as third prescribed equipment; and
the information processing method further comprising:
proposing to the user at the predetermined proposal timing that the third prescribed equipment be newly installed on the vehicle.

14. The information processing method according to claim 9, further comprising:
proposing to the user that the prescribed equipment, which, when installed on the vehicle, makes a residual value of the vehicle higher than a current value thereof, be newly installed on the vehicle.

15. The information processing method according to claim 9, further comprising:
obtaining information about the prescribed equipment from a predetermined database.

16. The information processing method according to claim 9, further comprising:
transmitting proposal information for proposing to newly install the prescribed equipment on the vehicle to a terminal related to the user at the predetermined proposal timing.

17. A non-transitory storage medium storing a program for causing a computer to perform an information processing method, the method comprising:
obtaining information about prescribed equipment that corresponds to a vehicle owned by a user, and is specified by a manufacturer of the vehicle as equipment that can be selected by the user; and
proposing to the user that the prescribed equipment be newly installed on the vehicle, at a predetermined proposal timing set based on inspection timings of the vehicle legally defined.

18. The non-transitory storage medium according to claim 17, wherein
in the information processing method,
the predetermined proposal timing, which is set based on a first one of the inspection timings after the user has owned the vehicle, is defined as a first proposal timing;
the prescribed equipment, which is not currently installed on the vehicle but has been considered by the use to be installed on the vehicle in the past, is defined as first prescribed equipment; and
at the first proposal timing, the user is proposed to newly install the first prescribed equipment on the vehicle.

19. The non-transitory storage medium according to claim 17, wherein
in the information processing method,
the predetermined proposal timing, which is set based on a second or subsequent one of the inspection timings after the user has owned the vehicle, is defined as a second proposal timing;
the prescribed equipment, which can be replaced with equipment currently installed on the vehicle, is defined as second prescribed equipment; and
at the second proposal timing, the user is proposed to newly install the second prescribed equipment on the vehicle.

20. The non-transitory storage medium according to claim 17, wherein
in the information processing method,
the prescribed equipment, which was not included in options selectable by the user when the user purchased the vehicle, is defined as third prescribed equipment; and
the user is proposed at the predetermined proposal timing to newly install the third prescribed equipment on the vehicle.
